(19) United States
(12) Patent Application Publication
(10) Pub. No.: US 2024/0241480 A1
(43) Pub. Date: Jul. 18, 2024

(54) WATCH CASE COMPRISING A REMOVABLE ROTATING BEZEL

(71) Applicant: Harry Winston SA, Plan-les-Ouates (CH)

(72) Inventors: Marc HUMBERT, Aire-La-Ville (CH); Johnny BÜHLER, Gingins (CH)

(73) Assignee: Harry Winston SA, Plan-les-Ouates (CH)

(21) Appl. No.: 18/400,203

(22) Filed: Dec. 29, 2023

(30) Foreign Application Priority Data
Jan. 16, 2023 (EP) 23151795.4

(51) Int. Cl. G04B 37/00

(52) U.S. Cl. CPC G04B 37/0041

(57) ABSTRACT

A watch case (10) including a middle (11), a bezel (12) and a connecting ring (13) arranged rotatable relative to the middle (11). The connecting ring (13) and the bezel (12) each include at least one interlocking member cooperating with each other when the bezel (12) is fastened to the middle (11) in order to eliminate any relative mobility between the connecting ring (13) and the bezel (12), the connecting ring (13) and the bezel (12) being configured so that when the bezel (12) is subjected to a force that goes against the resilient restoring force, the interlocking members no longer cooperate with each other so as to allow rotational and translational freedom between the connecting ring (13) and the bezel (12).

### CROSS REFERENCE TO RELATED APPLICATIONS

This application claims priority to European patent application Ser. No. 23/151,795.4 filed Jan. 16, 2023, the entire contents of which are incorporated herein by reference.

### TECHNICAL FIELD OF THE INVENTION

The invention relates to the field of watchmaking, particularly watch cases.

More particularly, the invention relates to a watch case comprising a removable rotating bezel.

### TECHNOLOGICAL BACKGROUND

Some watches have a case designed so that the bezel can be separate from the middle to which it is fastened without tools, i.e. comprising a bezel fastened to the middle in a removable manner.

In particular, this type of bezel allows the watch case to be customised, for example by replacing one bezel with another featuring different decorations, or facilitates maintenance operations.

One of the drawbacks of existing watch cases with removable bezels is the complexity of their manufacture and/or the complexity of their use, these drawbacks being even greater in the case of a rotating bezel.

There is thus a need to provide a removable rotating bezel that has a simple design, i.e. a design that comprises the smallest possible number of components, so that it is as easy as possible to manufacture, while allowing it to be removed from the middle or fastened to the middle in the most convenient way possible.

### SUMMARY OF THE INVENTION

The invention resolves the aforementioned drawbacks and, to this end, relates to a watch case comprising a middle, a bezel and a connecting ring arranged so as to be able to rotate relative to the middle and by means of which the bezel is able to be fastened to the middle in a position in which said bezel is forced to bear against said ring by a resilient restoring force generated by a resilient member. The connecting ring and the bezel each comprise at least one interlocking member cooperating with each other when the bezel is fastened to the middle, in order to eliminate any relative mobility between said connecting ring and said bezel.

The connecting ring and the bezel are configured so that when the bezel is subjected to a force that goes against the resilient restoring force, the interlocking members no longer cooperate with each other, so as to allow rotational freedom between said connecting ring and said bezel. The connecting ring and the bezel are further configured so that they can be separated when they are arranged in a predefined angular position relative to each other.

In particular embodiments, the invention can further comprise one or more of the following features, taken alone or in any combination technically possible.

In particular embodiments, the connecting ring comprises a peripheral shoulder by means of which it is arranged in abutment against an axial shoulder of the middle formed by a radial lip.

In particular embodiments, the interlocking members of the bezel and of the connecting ring respectively comprise a coupling element, said coupling elements having complementary shapes and cooperating with each other when the bezel is fastened to the middle and being separated from each other when the bezel is subjected to a force that goes against the resilient restoring force.

In particular embodiments, the coupling elements are configured, when the bezel is subjected to a force that goes against the resilient restoring force, to prevent rotation of the bezel relative to the connecting ring in a first direction of rotation and to allow rotation in a second direction of rotation opposite to the first direction of rotation.

In particular embodiments, the connecting ring comprises a toothing that cooperates with a resilient indexing element fastened to the middle.

In particular embodiments, the toothing is shaped so as to allow rotation of the connecting ring only in the first direction of rotation.

In particular embodiments, the interlocking members of the bezel and of the connecting ring each comprise a translation-stopping element, said translation-stopping elements cooperating with each other when the bezel is fastened to the middle and being released from each other when the coupling elements are separated from each other and the bezel and the connecting ring are arranged in the predefined angular position.

In particular embodiments, the translation-stopping elements of the bezel and of the connecting ring are each formed by a radial tongue, the tongues extending in opposite directions and each comprising an interface face via which they rest against each other when the bezel is fastened to the middle.

In particular embodiments, the coupling element of the connecting ring is formed by a recess defined between two radial bankings, one of which is formed by a lateral end of the translation-stopping element of the connecting ring, referred to as the “banking end”, the coupling element of the bezel being formed by a radial lug intended to be engaged in said recess.

In particular embodiments, the translation-stopping elements of the bezel and of the connecting ring are formed respectively by a radial tongue, the tongues extending in opposite directions and each comprising an interface face by which they cooperate, the interface face of the radial tongue of the connecting ring having an inclined portion arranged so as to generate an extra thickness at the banking end, said extra thickness forming the second radial banking.

### BRIEF DESCRIPTION OF THE FIGURES

Other features and advantages of the invention will become apparent from the following detailed description, which is given by way of example and is by no means limiting, with reference to the accompanying drawings in which:

FIG. 1 shows a front view of a watch case according to a preferred example embodiment of the invention;

FIG. 2 shows a cross-sectional view of the watch case in FIG. 1 taken along the cutting plane A-A;

FIG. 3 shows a cross-sectional view of the case in FIG. 1 taken along the cutting plane B-B;

FIG. 4 shows a cross-sectional view of the case in FIG. 1 taken along the cutting plane C-C;

FIG. 5 shows an exploded top view of the watch case in FIG. 1;

FIG. 6 shows an exploded, perspective, bottom view of the watch case shown in FIG. 1.

It should be noted that the figures are not necessarily drawn to scale for reasons of clarity.

### DETAILED DESCRIPTION OF THE INVENTION

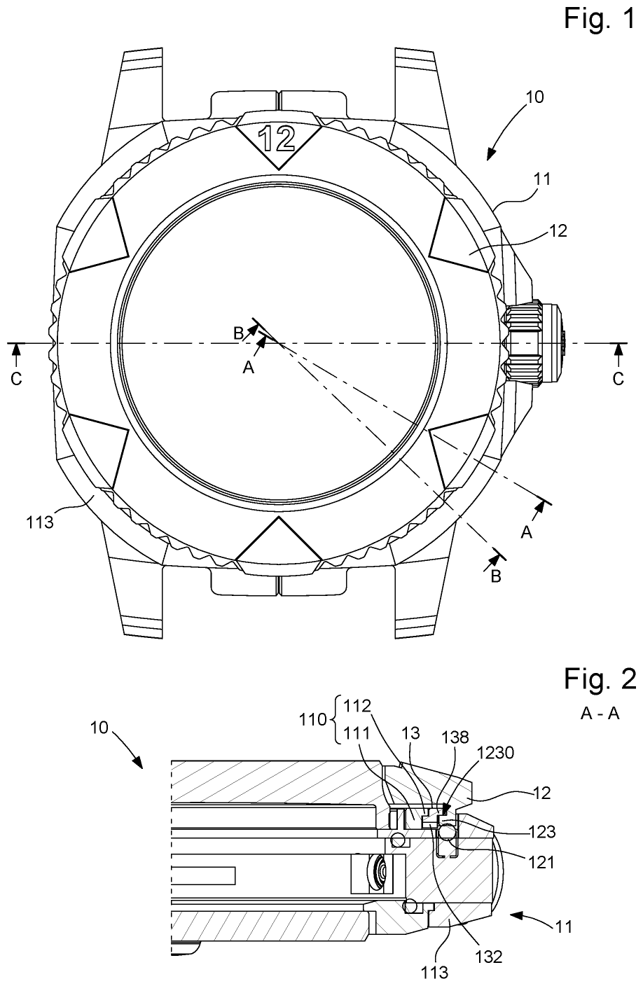

The invention relates to a watch case 10, as shown in FIGS. 1 to 6, comprising a middle 11 to which a bezel 12 is fastened by means of a connecting ring 13.

In particular, the connecting ring 13 is arranged so as to rotate relative to the middle 11, around a tubular part 111 of said middle 11. As shown in the cross-sectional views of FIGS. 2 to 4, the tubular part 111 is connected to a radial lip 112 forming an axial bearing surface against which the connecting ring 13 is arranged in abutment, and more precisely a peripheral shoulder of said connecting ring 13. This peripheral shoulder is formed by a tubular portion 131 extending from an annular base 132, said tubular portion 131 and the tubular part 111 being coaxial.

As shown in the cross-sectional view of FIG. 2, when the bezel 12 is fastened to the middle 11, it is forced to bear against the connecting ring 13 by a resilient restoring force generated by at least one resilient member 121. This bearing allows interlocking members comprised within the connecting ring 13 and the bezel 12 respectively to cooperate with each other in order to eliminate any relative mobility between said connecting ring 13 and said bezel 12.

It is understood here that, thanks to the connecting ring 13, the bezel 12 benefits from a degree of rotational freedom in relation to the middle 11 when it is fastened thereto.

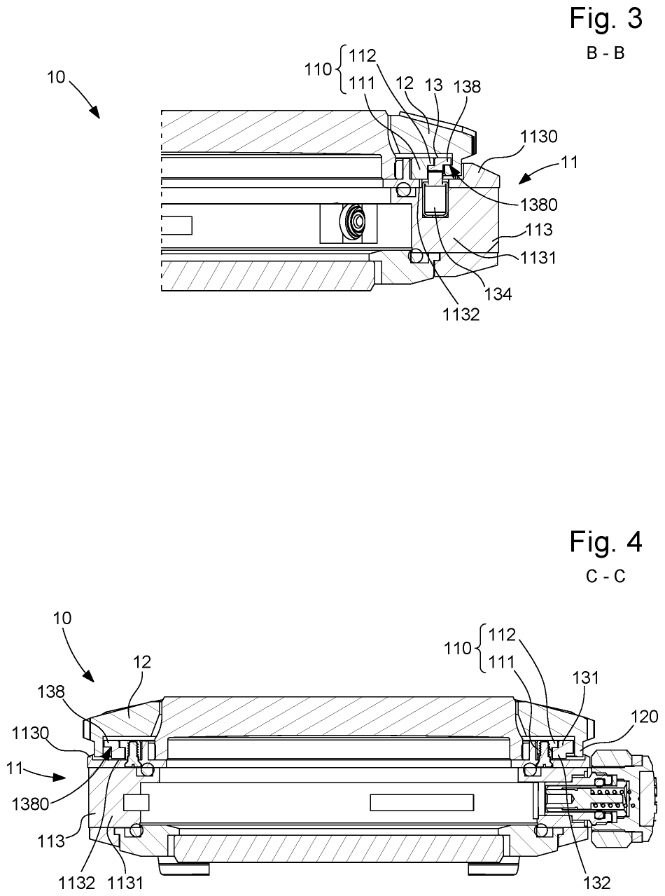

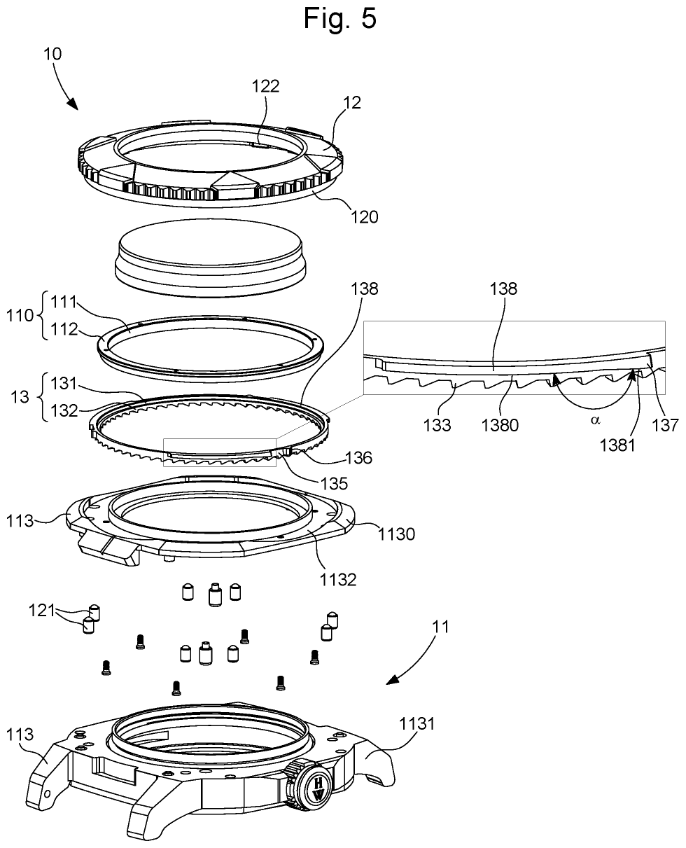

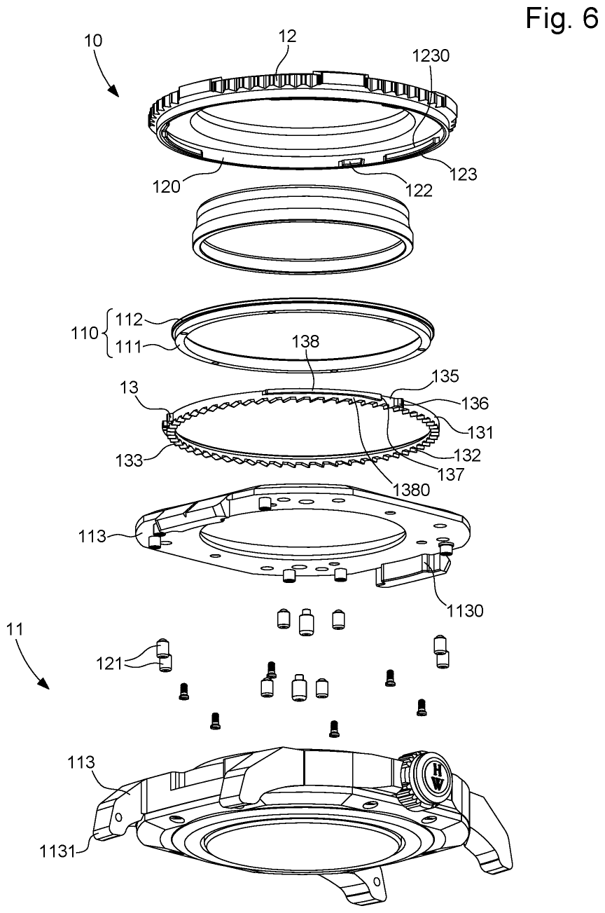

Advantageously, as can be seen in FIGS. 5 and 6, the connecting ring 13 comprises, on its annular base 132, a toothing 133 cooperating with a resilient indexing element 134 fastened to the middle 11, as can be seen in FIG. 3. Preferably, the toothing is shaped in such a way as to allow rotation of the connecting ring 13 only in a particular direction of rotation, referred to as the “first direction of rotation”. As a result, the bezel 12 is able to pivot in a single direction of rotation relative to the middle 11.

Advantageously, the connecting ring 13 and the bezel 12, and in particular their respective interlocking members, are configured so that when the bezel 12 is subjected to a force that goes against the resilient restoring force, the interlocking members no longer cooperate with each other and thus release the bezel 12 to rotate relative to said connecting ring 13. It should be noted that when the bezel 12 is subjected to a force that goes against the resilient restoring force, it is displaced axially by a distance that is only necessary to allow the interlocking members to be disengaged, as described in more detail below; this axial displacement is not, or is barely, perceptible to the user.

The bezel 12 can be removed from the case 11 only after it has been rotated through a particular angle. In other words, when the bezel 12 is subjected to a force that goes against the resilient restoring force, the bezel 12 and the connecting ring 13 can be separated by being arranged at a predefined angular position relative to each other.

The fact that the bezel 12 must be subjected to a force that goes against the resilient restoring force generated by the one or more resilient members 121 in order to remove the bezel 12 from the middle 11 prevents any accidental separation of the bezel 12 from the middle 11, and thus helps to secure the fastening of said bezel 12.

The interlocking members of the bezel 12 and of the connecting ring 13 are visible in the exploded views of FIGS. 5 and 6 and each comprise a coupling element. According to its accepted definition in the field of mechanics, a coupling allows a rotational movement to be transmitted between two parts. When the interlocking members cooperate with each other, the coupling elements thus allow the bezel 12 and the connecting ring 13 to rotate as one.

To this end, the coupling element of the connecting ring 13 is formed, in the preferred example embodiment, by a recess 135 defined between two radial bankings. In this example embodiment, the radial bankings extend outwards. The coupling element of the bezel 12 is formed by a radial lug 122, visible in FIG. 6, of a shape complementary to that of the recess 135 and engaged in said recess 135 when the interlocking members of the bezel 12 and of the connecting ring 13 cooperate with each other. In particular, this radial lug 122 extends from a skirt 120 of the bezel 12.

Preferably, the coupling elements are advantageously configured to prevent rotation of the bezel 12 relative to the connecting ring 13 in the first direction of rotation, when the bezel 12 is subjected to a force that goes against the resilient restoring force.

The first direction of rotation of the bezel 12 corresponds to its single direction of rotation relative to the middle 11 when it is fastened thereto. This eliminates the risk of accidentally separating the bezel 12 from the middle 11 during rotation.

To this end, one of the radial bankings, referred to below as the “first radial banking” 136, extends axially over a distance such that it constitutes a banking for the radial lug 122 whatever the axial position of the bezel 12, i.e. whether or not it is subjected to a force opposed to the resilient restoring force.

The interlocking members of the bezel 12 and of the connecting ring 13 each further include a translation-stopping element, as can be seen in FIGS. 2, 3, 5 and 6. The translation-stopping elements cooperate with each other when the bezel 12 is fastened to the middle 11 and are released from each other when the coupling elements are separated and when the bezel 12 and the connecting ring 13 are arranged in the predefined angular position relative to each other.

More specifically, the translation-stopping elements of the bezel 12 and of the connecting ring 13 are formed respectively by a radial tongue 123, 138 each comprising an interface face 1230, 1380 via which they rest against each other when the bezel 12 is fastened to the middle 11. In the preferred example embodiment of the invention, the tongue 138 of the connecting ring 13 extends outwards and that of the bezel 12 extends inwards.

The tongues 123 and 138 both extend between two lateral ends defining an angular sector large enough to distribute the axial forces on the interface faces 1230, 1380 in a manner adapted to maximise resistance to mechanical stresses.

Preferably, one of the radial bankings, referred to as the “second radial banking” 137, is formed by a lateral end of the tongue 138 of the connecting ring 13, referred to hereinafter as the “ banking end”.

When the bezel 12 is fastened to the middle 11, the tongues 123 and 138 of the bezel 12 and of the connecting ring 13 are arranged so as to bear against one another by means of their interface faces 1230, 1380, which makes it possible to prevent the bezel 12 from being removed from the middle 11 by a translational motion, then the bezel 12 is pivoted relative to the middle 11 until the radial lug 122 of the bezel 12 engages in the recess 135 under the action of the resilient restoring force and comes into contact with the first radial banking 136.

In the preferred example embodiment and as shown in the detail view of FIG. 5, the interface face 1380 of the tongue 138 of the connecting ring 13 has an inclined portion 1381 arranged so as to generate an extra thickness at the banking end. In particular, said interface face 1380 comprises a first portion against which the interface face 1230 of the tongue 123 of the bezel 12 rests when the bezel 12 is fastened to the middle 11, and a second portion, constituted by the inclined portion 1381, forming, with the first portion, a non-flat angle α, for example of between 145 and 175 degrees. In summary, the extra thickness generated by this second portion forms the second radial banking 137.

This feature helps to simplify the design and manufacture of the interlocking members.

Advantageously, in order to facilitate assembly of the case 10, the middle 11 can comprise a fastening ring 110 intended to fasten the connecting ring 13 to said middle 11 while allowing a degree of rotational freedom of said connecting ring 13 relative to said middle 11. More specifically, the fastening ring 110 comprises the tubular part 111 and the radial lip 112, and is fastened to a middle body 113, for example by screwing.

The middle body 113 can comprise a joining piece 1130 fastened to a central part 1131 of the middle body 113, for example by screwing, and comprising an annular groove 1132 intended to receive the fastening ring 110, the connecting ring 13 and the skirt 120 of the bezel 12. In particular, the annular groove 1132 is defined between an inner flank and an outer flank connected to each other by a base. In the example shown in the cross-sectional views of FIGS. 2 to 4, the fastening ring 110 is arranged facing the inner flank and the bezel 12 is arranged facing the outer flank.

The resilient indexing element 134 and the resilient member 121 are housed in the central part 1131 of the middle body 113 and extend through the bottom of the annular groove 1132.

It is understood from the foregoing that the bezel 12, when fastened to the middle 11, is translationally mobile with a clearance defined between bankings formed by the bottom of the annular groove 1132 and by the interface face 1380. This clearance is only necessary, as indicated above, to separate the coupling elements from each other.

The joining piece 1130 is fastened to the central part 1131 in a preferably removable manner, so as to simplify any maintenance operations and to allow part of the middle 11 to be customised, in addition to the possibility of customising the bezel 12.

More generally, it should be noted that the example embodiments considered above have been described by way of non-limiting examples, and that other alternative embodiments are thus conceivable.

In particular, although in the example embodiment described above, the radial lip 112 of the fastening ring 110, the first radial banking 136 and the tongue 138 of the connecting ring 13 extend outwards, and the annular base 132 of the connecting ring 13, the tongue 123 and the radial tab 122 extend inwards, an arrangement of these elements in the opposite direction could be envisaged. In other words, the radial lip 112, the first radial banking 136 and the tongue 138 of the connecting ring 13 could extend inwards, and the annular base 132, the tongue 123 and the radial lug 122 could extend outwards.

Moreover, the bezel 12 and the connecting ring 13 can each comprise several interlocking members, for example three, as shown in the figures.

It is also possible, in order to form the second radial banking 137, to replace the inclined portion 1381 with a similar projecting portion, for example formed by a pin, an appropriately shaped extra thickness, etc. It is also possible for the interface face 1380 to form a single inclined section to form the second radial banking 137, the cross-section of the tongue 138 thus increasing towards the recess 135. It is also possible to axially offset the radial tab 122 relative to the tongue 123 of the bezel 12, so that when said tongue 123 bears against the tab 138 of the connecting ring 13, the radial tab 122 is housed in the recess 125. This last example allows the tongue 138 of the connecting ring 13 to take any shape.

1. A watch case (10), comprising:
a middle (11);
a bezel (12); and
a connecting ring (13) arranged so as to be able to rotate relative to the middle (11) and by means of which the bezel (12) is fastened to the middle (11) in a position in which said bezel (12) is forced to bear against said ring by a resilient restoring force generated by a resilient member (121),
the connecting ring (13) and the bezel (12) each comprising at least one interlocking member cooperating with each other when the bezel (12) is fastened to the middle (11), in order to eliminate any relative mobility between said connecting ring (13) and said bezel (12),
the connecting ring (13) and the bezel (12) being configured so that when the bezel (12) is subjected to a force that goes against the resilient restoring force, the interlocking members no longer cooperate with each other and thus allow rotational freedom between said connecting ring (13) and said bezel (12),
the connecting ring (13) and the bezel (12) being further configured so as to be able to be separated when they are arranged in a predefined angular position relative to each other.

2. The watch case (10) according to claim 1, wherein the connecting ring (13) comprises a peripheral shoulder by means of which it is arranged in abutment against an axial bearing surface of the middle (11) formed by a radial lip (112).

3. The watch case (10) according to claim 2, wherein the interlocking members of the bezel (12) and of the connecting ring (13) respectively comprise a coupling element, said coupling elements having complementary shapes and cooperating with one another when the bezel (12) is fastened to the middle (11) and being separated from one another when the bezel (12) is subjected to a force that goes against the resilient restoring force.

4. The watch case (10) according to claim 3, wherein the coupling elements are configured, when the bezel (12) is subjected to a force that goes against the resilient restoring force, to prevent the rotation of the bezel (12) relative to the connecting ring (13) in a first direction of rotation and to allow its rotation in a second direction of rotation opposite to the first direction of rotation.

5. The watch case (10) according to claim 1, wherein the connecting ring (13) comprises a toothing cooperating with a resilient indexing element (134) fastened to the middle (11).

6. The watch case (10) according to claim 4, wherein the connecting ring (13) comprises a toothing cooperating with a resilient indexing element (134) fastened to the middle (11), the toothing being shaped so as to allow rotation of the connecting ring (13) only in the first direction of rotation.

7. The watch case (10) according to claim 3, wherein the interlocking members of the bezel (12) and of the connecting ring (13) respectively comprise a translation-stopping element, said translation-stopping elements cooperating with each other when the bezel (12) is fastened to the middle (11) and being released from each other when the coupling elements are separated from each other and when the bezel (12) and the connecting ring (13) are arranged in the predefined angular position.

8. The watch case (10) according to claim 7, wherein the translation-stopping elements of the bezel (12) and of the connecting ring (13) are formed respectively by a radial tongue (123, 138), the tongues (123, 138) extending in opposite directions and each comprising an interface face (1230, 1380) via which they rest against one another when the bezel (12) is fastened to the middle (11).

9. The watch case (10) according to claim 7, wherein the coupling element of the connecting ring (13) is formed by a recess (135) defined between two radial bankings (136, 137), one of which is formed by a lateral end of the translation-stopping element of the connecting ring (13), referred to as the “banking end”, the coupling element of the bezel (12) being formed by a radial lug (122) intended to be engaged in said recess (135).

10. The watch case (10) according to claim 9, wherein the translation-stopping elements of the bezel (12) and of the connecting ring (13) are formed respectively by a radial tongue (123, 138), the tongues (123, 138) extending in opposite directions and each comprising an interface face (1230, 1380) via which they cooperate, the interface face of the tongue (138) of the connecting ring (13) having an inclined portion (1381) arranged so as to generate an extra thickness at the banking end, said extra thickness forming the second radial banking (137).
